(19) United States
(12) Patent Application Publication
(10) Pub. No.: US 2008/0021706 A1
(43) Pub. Date: Jan. 24, 2008

(54) SPEECH DISTRIBUTION SYSTEM

(75) Inventor: Frederick J. Bruwer, Paarl (ZA)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(73) Assignee: Azoteq (Pty) Ltd

(21) Appl. No.: 11/834,195

(22) Filed: Aug. 6, 2007

Related U.S. Application Data
(63) Continuation of application No. 10/149,362, filed on Aug. 28, 2002, now abandoned.

(30) Foreign Application Priority Data
Sep. 12, 1999 (ZA) 99/7564

(51) Int. Cl. G10L 15/20

(52) U.S. Cl. 704/233; 704/E15.039

(57) ABSTRACT

A method of distributing speech which includes the steps of, at a given location, receiving an audio signal, extracting from the audio signal a signal representing speech originating from or near the location, and distributing an electric signal which is mixed with the extracted speech signal via an audio system to be played over at least one loudspeaker.

### CROSS-REFERENCE TO RELATED APPLICATIONS

This is a continuation of co-pending application Ser. No. 10/149,362 having filing date of Aug. 28, 2002, which is in turn the U.S. nationalization of international patent application PCT/ZA00100244 having an international filing date of Dec. 7, 2000.

### BACKGROUND OF THE INVENTION

his invention relates to a speech distribution system. In certain situations it may be difficult to hear speech audibly or clearly due to noise, other sounds or attenuation of the speech sound waves. For example in a motor vehicle, road and background noise may effectively render the spoken word inaudible. This type of problem is compounded when the driver of a vehicle is attempting to communicate with people who are relatively far from the driver, for example in rear seats. Quite often, especially in a minibus or similar vehicle which has three or four rows of seats, it may be necessary for the driver to turn his head in order to project his voice towards the rear of the vehicle. This can have dangerous consequences for the driver's attention is drawn from the road. On the other hand, projecting the sound forward causes undue attenuation thereof, especially in cars with good noise dampening.

Ironically, the better the sound dampening is in a vehicle (to reduce engine and road noise), the greater is the dampening effect on speech which is projected forward from occupants in the front seats and which is directed to passenger in the rear.

Equally, in the reverse sense, speech originating from the rear of a vehicle may be drowned out by background noise which may include sound emanating from an audio system, such as a radio/tape/CD unit, of the vehicle. Ideally, a situation should be created in which conversation can flow in a natural manner. This will enable the driver to engage pleasantly in conversation with fellow passengers while keeping a proper look out.

### SUMMARY OF THE INVENTION

The invention provides a method of distributing speech which includes the steps of:
(a) at a given location, receiving an audio signal,
(b) extracting from the audio signal a signal representing speech originating from or near the location, and
(c) distributing an electric signal which is mixed with the extracted speech signal via an audio system to be played over at least one loudspeaker.

Step (b) is preferably carried out using adaptive filters, echo cancellation and other digital signal processing techniques.

The said signal may be distributed through at least one loudspeaker.

The said signal may be distributed to a plurality of loudspeakers at locations which may exclude the said given location.

The method of the invention may be implemented inside a vehicle and the locations may respectively correspond to seating positions inside the vehicle.

The loudspeaker referred to may be one of a plurality of loudspeakers which form part of an audio system inside a vehicle.

The method may include the step of varying the signal strength of the said signal which is distributed. Thus signals which have different strengths, depending on prevailing conditions and requirements, may be distributed to respective locations. The signal strength may be varied per location such that, for example, in a vehicle with three rows of seats the driver can converse with a passenger who is seated in the rearmost row, directly behind the driver. The signal level to other passengers may be turned down. The signal strength of the distributed signal may be greater in a situation with severe background noise and, for example at high vehicle speed, the strength of the speech signal can also be high.

If use is made of the loudspeakers of an audio system then the speech signal which is distributed may vary in strength in accordance with the strength or amplitude of an audio signal, music or otherwise, which is being transmitted on the audio system.

If different audio signals are received at respective locations then signals which correspond to each extracted speech signal may be distributed to the various locations but preferably excluding, in each case, the respective location from which an extracted signal originated to prevent an echo effect or positive feedback. If no additional wiring can be accommodated in the speech distribution system the locally received signals at the various locations may be filtered and may be shifted in frequency so that they can be transmitted to a central unit on the same conductive lines which are used for the transmission of audio signals from a central audio or control unit to the loudspeakers. This allows the distributed signal or signals to be mixed with signals originating from the audio system, for example radio or music signals, without any interference.

Time delays may be imparted to distributed signals to eliminate echo effects since the signals travelling via wire to the various locations travel much faster than soundwaves (speech) from the person speaking to the same locations.

The invention also provides apparatus for distributing speech which includes a receiving device for receiving an acoustic signal (noise, music, speech, etc.) from one of a plurality of locations, a module for extracting from the acoustic signal a signal which represents speech originating at or close to that location, and a unit for distributing an amplified signal, which includes the extracted speech signal, to at least some of the said plurality of locations.

The speech signal may be distributed to each of the said plurality of locations although, preferably, the location from which the said acoustic signal was received, is included.

The said extracted signal preferably represents the speech (in question) as best possible.

### BRIEF DESCRIPTION OF THE DRAWINGS

The invention is further described by way of examples with reference to the accompanying drawings in which:

FIG. 1 is a block diagram representation of apparatus for distributing speech in accordance with the invention,

FIG. 1a illustrates a variation to the apparatus of FIG. 1 in which use is made of an additional hard wire connection to the microphone,

FIGS. 2 and 2a are similar to FIGS. 1 and 1a respectively, illustrating a more complex system of distributing speech in accordance with the invention, using multiple microphones,

FIG. 3 illustrates a distribution module for use in the method of the invention,

FIG. 4 illustrates a main unit for use in the method of the invention,

FIG. 5 illustrates possible frequency utilisation by an audio system in a vehicle,

FIGS. 6, 7 and 8 respectively represent different embodiments of the invention,

FIG. 9 shows a system which is equivalent to that in FIG. 1a, but with a main unit depicted in greater detail, and

FIG. 10 is a schematic representation of a console which includes a loadspeaker, microphones and control buttons.

### DESCRIPTION OF PREFERRED EMBODIMENTS

The invention is based on the use of techniques of adaptive filters and echo cancellation to extract local speech from a signal carrying music, noise and speech and to distribute a resulting speech signal to one or more locations inside a vehicle. The invention can be effectively implemented making use of an audio system such as a radio/tape/CD system, inside a vehicle, which is connected to a plurality of loudspeakers and some microphones strategically placed inside the vehicle.

The principles of the invention can be described by the following generalised example.

Assume a four seater vehicle has a stereo radio/CD audio system with four speakers (left front, right front, left back, right back) and that a system according to the invention is integrated with the audio system. Four microphones are present, one at each seat.

A main unit has “a priori” information about the audio signal (ASe) originating from the radio/CD system. Without any other audio signal (from occupants, road noise, etc.) the signal detected by a microphone is a function (F) of ASe. This function is the complex result of the speaker transfer function, the attenuation over the air and through objects (seats etc.), sound reflections from objects, (windows etc.), the microphone transfer function, multiple paths along which the soundwaves travel, and the like.

Since ASe (reference signal from audio unit) is known and the result as measured by the microphone in the absence of other sounds is known, it is possible to model this transfer function using echo cancelling techniques and some fault minimisation algorithm, like a least means square (LMS) algorithm. Since other signals are also present in the microphone signal the calculations are a little more complex but techniques of this type are described in the art. Because other signals like the driver speech signal are not normally correlated with the signals from the audio unit, they will not statistically influence the filter adaptation over a period of time. The modelling results in a signal ASe.sup.1. Subtracting ASe.sup.1 from the microphone signal leaves the signals representing the speech and other noise.

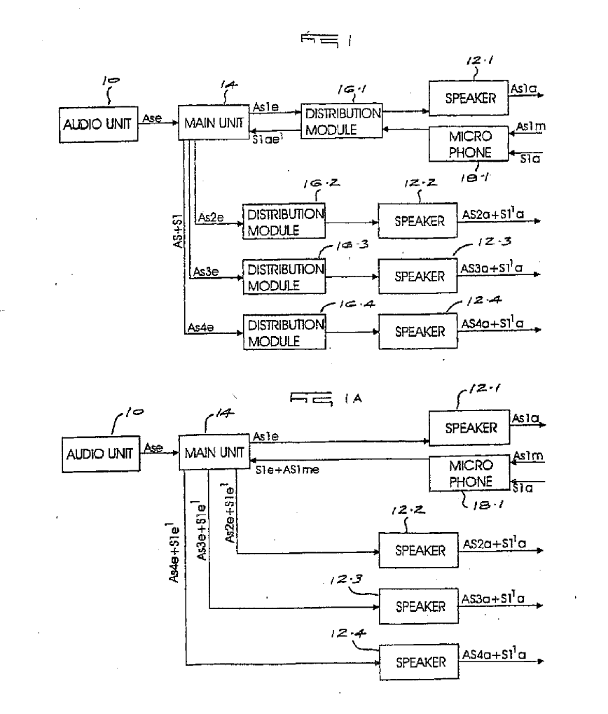

FIG. 1 illustrates a first form of the invention. A vehicle, not shown, includes an audio unit 10 such as a radio/tape/CD system which, normally, is directly connected, in a known manner, to four loudspeakers 12.1, 12.2, 12.3 and 12.4 respectively. A main unit 14 and four distribution modules 16.1, 16.2, 16.3 and 16.4 respectively are connected between the audio unit and the respective loudspeakers. The distribution module 16.1 is connected to a microphone 18.1.

FIG. 1a illustrates a modified version of the form of the invention shown in FIG. 1, wherein the signal from the microphone 18.1 is carried by wire to the main unit 14. This embodiment has a single microphone that may be targeted at the driver or all occupants in the front seat.

Each loudspeaker may include more than one speaker, such as low frequency, midrange and tweeter devices.

It is to be borne in mind that the invention does not emulate the operation of a public address system in which an audio signal present at an input is amplifed indiscriminately. This invention aims to achieve a mix of the voice signal with the prevailing music or other audio entertainment without changing the ambience by an overbearing signal amplification.

The signal processing also removes the requirement for the microphone to be very close to, or specifically targeted at, the respective speaker.

The construction of the main unit and the construction of each distribution module are described hereinafter.

Note that in the following description the addition of the symbol “e” as a suffix to a sound signal denotes the electrical representation of such sound signal.

The audio unit 10 produces an audio signal AS (electrical counterpart ASe) which is transmitted through the main unit 14 and the distribution modules 16 to the respective loudspeakers 12.1 to 12.4. This aspect is normally substantially conventional and is not further described herein. In fact, this aspect is similar to a situation without the main unit and the distribution modules.

Assume that the loudspeaker 12.1 and the microphone 18.1 are associated with the position of the seat of the driver of the vehicle (in FIG. 1 and in FIG. 1a). Assume that the driver speaks and thereby generates a speech signal which is designated S1a. The speech signal is detected by the microphone 18.1 which also detects AS1m, the result of the sounds originating from the various speakers in the vehicle plus other noise. The combined speech and acoustic signals are input to the distribution module 16.1 (FIG. 1) which compares the incoming signal AS1e, from the main unit, to the signals produced by the microphone 18.1, i.e. the combination, or sum, of AS1me+S1ae (the electrical representations of AS1m and S1a respectively). S1ae is identified as being additional and is extracted from the combined signal from the microphone. The extraction is done by modelling the transfer function of ASe through the speaker and the microphone using adaptive filtering techniques and then subtracting the estimated AS1e.sup.1 from AS1me+S1ae to yield S1ae.sup.1. The last mentioned signal, S1ae.sup.1, which represents the estimated speech (electrical form) originating from the driver, and noise, is then available in the main unit. The main unit 14 combines the signal ASe going to each loudspeaker from the audio unit 10 with the signal S1ae.sup.1 This process is carried out for each speaker. ASxe+S1ae.sup.1. is then transmitted to each of the distribution modules 16.2, 16.3 and 16.4, where x corresponds to the particular speaker (2,3 or 4) in this four speaker example. The combined signal is typically not transmitted to the module 16.1 which is associated with the source of origin of the speech signal.

The combined signal ASxe+S1ae.sup.1 is transmitted to the various loudspeakers 12.2 to 12.4 which are associated with different seats in the vehicle. Persons seated at these seats therefore hear a signal which consists of the audio signal originating from the audio unit 10 in accordance with the volume setting (including left/right balance and back/front balance) and the superimposed speech signal which is derived from the driver. Thus, with the system shown in FIG. 1, the drivers speech signal is automatically transmitted to all loudspeakers except possibly the loudspeaker which is associated with the driver. Clearly this speech may be amplified at will but the system displays the added advantage that acoustic signal is not attenuated by the sound (noise) dampening technologies in the vehicle, nor is the attenuation of the acoustic signal attenuated over distance.

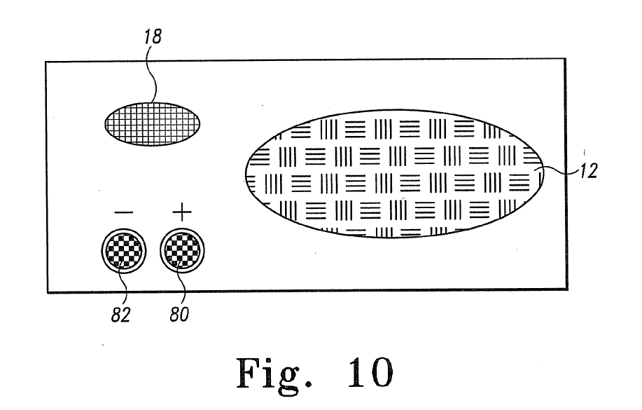

If additional wiring or other medium of transfer from the microphone to the main unit can be accommodated a system as shown in FIG. 1a is preferred, failing which distribution modules may be used as shown in FIG. 1. It would also be possible to adjust the amplitude of the speech (S1) to the various speakers individually (see FIG. 10). The volume settings in FIG. 10 may be for the speech signals only or for a combination of speech and music or for signals from the audio unit 10 only.

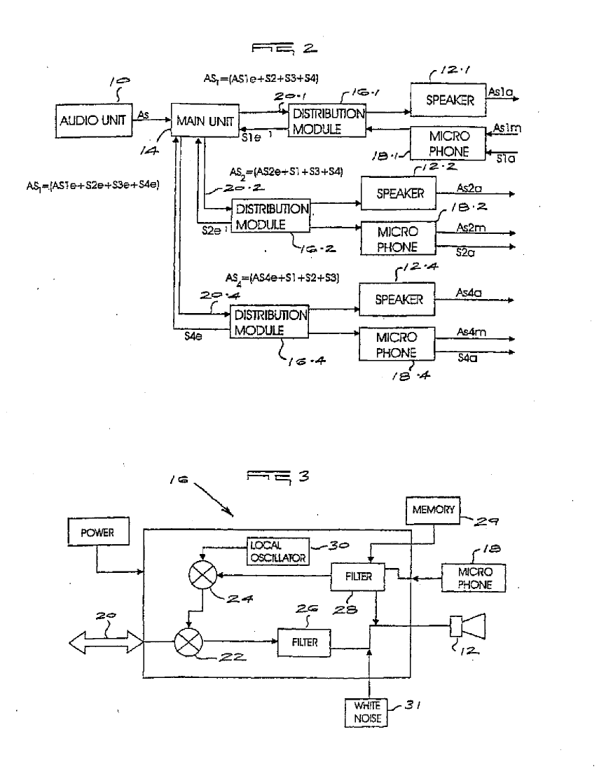

The system shown in FIG. 1 can be developed to ensure that a speech signal which may originate at any location is transmitted, using the audio system of the vehicle, to all other locations excluding possibly the location of origin. This is shown in FIGS. 2 and 2a.

It is to be noted that in the arrangement of FIG. 1 the adaptive filtering to extract the speech may be done in the distribution module or the main unit, whereas the system in FIG. 1a would use techniques of the type described hereinafter with reference to FIG. 9 with the filtering as part of the main unit.

In FIG. 2 microphones 18.1 to 18.4 are associated with the positions at loudspeakers 12.1 to 12.4 respectively. It is assumed that speech signals S1 to S4 are originated at the respective locations of the loudspeakers 12.1 to 12.4 and are detected by respective microphones 18.1 to 18.4. Using techniques analogous to that described in connection with FIGS. 1 and 1a the various speech signals are combined with the audio signal originating from the audio unit and the resulting combinations are distributed to the various speakers. Thus the loudspeaker 12.1 receives a signal AS1 consisting of (AS1e+S2+S3+S4); the loudspeaker 12.2 receives a signal AS2 which is equal to (AS2e+S1+S3+S4); the loudspeaker 12.3 receives a signal AS3 equal to (AS3e+S1+S2+S4) and the loudspeaker 12.4 receives a signal AS4 which is equal to (AS4e+S1+S2+S3); (where SN is the speech signal detected by the microphone 18N). An attempt is made to distinguish between the ideal value say S1 and S1e, respectively representing the speech and the microphone output thereof, and the estimation thereof which is done by the digital signal processing and which is denoted as S1e.sup.1

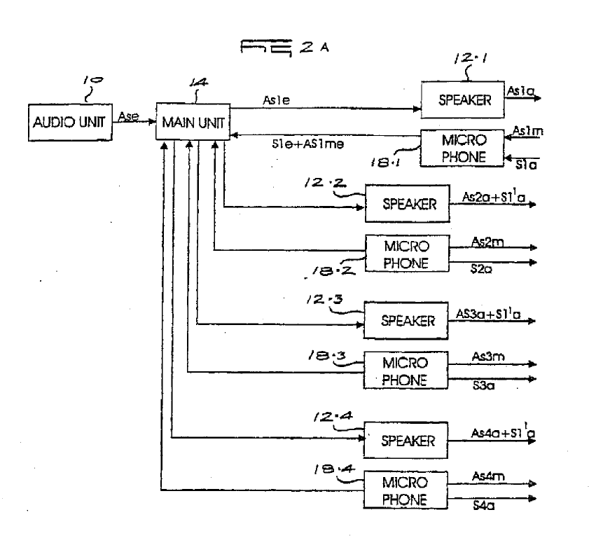

FIG. 3 illustrates in block diagram form the construction of a distribution module 16. The module is connected to a microphone 18 and a loudspeaker 12, and a speaker wire 20 extends from the main unit 14, not shown, to the distribution module. The speaker wire 20 carries the signals from the main unit to the distribution module and the speech and other signals which are transferred between the distribution module and the main unit. In FIGS. 1 and 2, separate lines are shown for these signals but this is merely for convenience. As is described hereinafter frequency shifting or translation may be used to enable both signals to be transmitted on a single line.

The module 16 includes mixers 22 and 24 respectively and first and second filters 26 and 28 respectively.

The filter 26 is a band pass filter extending for example from 1000 Hz to 20 kHz and is suitable for speech and music transmission. The purpose of this filter is to filter out a signal of speech and other sounds which are picked up by the local microphone 18, frequency shifted by the mixer 24 and local oscillator 30 and then mixed into the line by the mixer 22.

The filter 28 is a dynamic adaptive digital filter mechanism. The filter is implemented by dynamically adjusting the coefficients of an FIR-type filter so that all sounds which are detected by the microphone 18 and which are correlated with the sounds which are output to the loudspeaker 12, are cancelled out as best as possible. This technique can be implemented using a least means square error principle (LMS). The quality of the cancellation is determined by the quality of the digitization, length of filter, etc. As is usual a trade off with cost is required.

The system can be designed so that the adaptive filter can estimate the transfer function as part of the installation procedure. The resultant filter coefficients can then be stored in a non-volatile memory 29 and can be used every time the system is powered up. This approach prevents the adaptation process from starting at a random or an all-zero vector, speeds up the adaptation process, and helps to prevent spurious transients at start up.

The system can also be designed to store new coefficients when it is determined that the transfer function has changed, or has changed by more than a minimum setting. This can result when large objects are placed in a vehicle, when there is a change in passenger numbers, a change in balance (UR, F/B) and many more.

The filter 28 can also include a stage in which the output, typically the speech originating near a microphone 18, is filtered over the speech band, from say 300 Hz to 6 kHz, to keep noise out of the system. Alternatively the speech band filter can be positioned between the microphone and the filter 28. An anti-aliasing filter is required in any event.

The mixer 24 multiplies the signal which is transmitted to the main unit 14 with a signal from a local oscillator 30 so that the signal is translated in frequency. The mixer 22 mixes this signal with the signal AS from the main unit and allows both signals, i.e. the audio signal and the speech signal, to be impressed on the speaker wire 20 at different locations in the frequency spectrum.

It may be advantageous to add a low level of white noise to the signal from the audio system (radio/CD etc.) before this signal is output on the speakers. The adaptive filter 28 needs to build a model of the transfer function between the electrical signal before the speakers to the electrical signal after the microphone. In order to do so the filter requires energy over the whole frequency spectrum and since this cannot be guaranteed for all music and sounds from the audio system, it may be prudent to add the white noise from a source 31 for a short time period to help estimate the transfer function at all frequencies.

The noise level should be very low so that it does not irritate a listener. The white noise needs to be added only for about a second and the addition thereof should not prove to be a source of annoyance to the occupants of the vehicle. It may be necessary to repeat this from time to time.

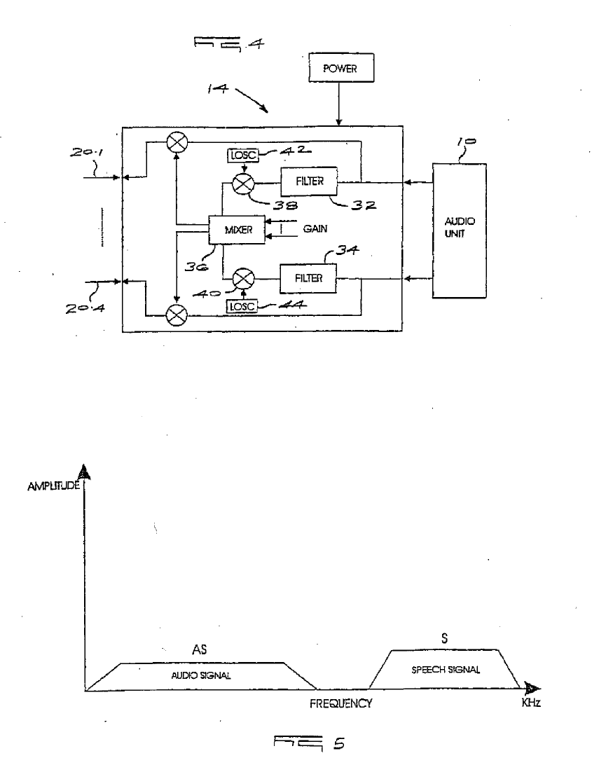

FIG. 4 illustrates a main unit 14 in block diagram form. The main unit includes third and fourth filters 32 and 34 respectively, mixers 36, 38 and 40 and local oscillators 42 and 44 respectively. The mixer 36 assesses the gain coefficient or factor of the audio unit 10 and multiplies the speech signal which is input on the respective speaker wire 20 with the gain coefficient and mixes the resulting signal with the audio signal which is then transmitted to each loudspeaker except possibly to the loudspeaker of origin of the speech signal. The gain of the loudspeaker of origin is preferably zero or lower than the others to ensure that there is no echo and that positive feedback does not occur.

It is also important to ensure that the sound from the microphones is processed in such a way that background noise is eliminated as far as possible. This can also be done using dynamic adaptive filtering techniques. For example, a continuous sine wave can easily be identified as a non-speech signal and then removed with a sharp filter.

The system can also be used to adapt sound levels at the different loudspeakers to prevailing conditions.

An important function that can be designed into the system is that of automatic volume control. A radio and music volume setting that may be acceptable at a high speed with an attendant high background noise level will probably be too loud when the vehicle speed is much lower.

The system has access to signals which represent noise and sound levels and which can be analysed to make a decision on automatically adjusting the volume control to a different level. With a digital signal processor available and microphones placed strategically in various places inside the vehicle, it is possible to extract the required parameters (road and engine noise levels) and to make the necessary adjustments to ensure a pleasant audio experience for the vehicle's occupants.

The system can also shut down if no voice signal is present and can be integrated with cell phone technology to provide hands-free working.

The filters 32 and 34 extract the frequency translated speech signal input on the speaker wire 20 by removing the baseband signals and the mixers 38 and 40 translate the speech signal to the base band. In the mixer 36 the audio signal is mixed with the speech signals from each of the locations and is then distributed to each loudspeaker except, possibly, for each speech signal, the respective location of origin.

FIG. 5 illustrates frequency utilisation on a loudspeaker wire 20. The audio signal AS originating from the audio unit 10 occupies a first frequency band (baseband) while the speech signal S, detected at a given location, is translated in frequency and is positioned at a relatively high frequency. Thus AS and S are not mixed, in a frequency sense, and can be transmitted over a single wire. As has been indicated, for the speech signal S to be audible in a conventional manner, the speech signal S is shifted downwards in frequency to the baseband before reaching the respective loudspeakers. Systems using additional hard wires (or other medium like RF) to carry the signals from the various microphones to the main unit are much simpler without the need to filter and frequency shift to such an extent (see FIGS. 1a, 2 and 9).

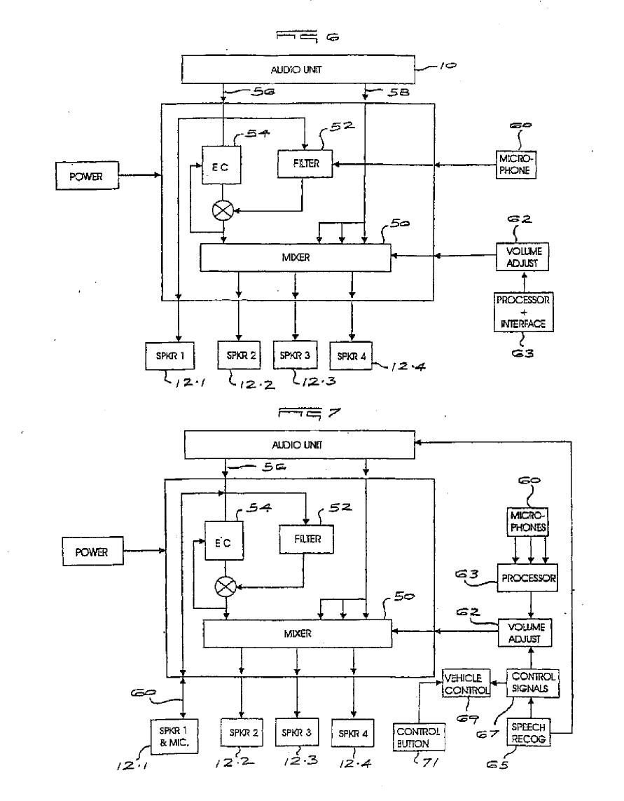

FIG. 6 illustrates in block diagram form another example of a system which is substantially the same as the system illustrated in FIG. 1 in that speech originating only from a single location, for example from the driver of a vehicle, is distributed to the various speakers in an audio system except the loudspeaker associated with the driver.

The speech distribution system includes a mixer 50, a filter 52 and an echo cancellation mechanism 54. Four loudspeakers 12.1, 12.2, 12.3 and 12.4 are included in the audio system. A speaker wire 56 extends from the audio unit 10 and is destined for the speaker 12.1 associated with the driver. A speaker wire 58 which is destined for the speakers 12.2, 12.3 and 12.4 extends from the audio unit to the mixer 50. A microphone 60 is associated with the speaker 12.1 and is positioned to detect speech from a driver of the vehicle

The filter 52 is an analogue or digital filter which extracts a speech signal originating from the driver. If use is made of a digital filter then the filter includes an analogue anti-aliasing filter. This would typically be a 300 Hz to 3 kHz (or 6 kHz) bandpass filter.

The echo cancellation mechanism 54 is a dynamically adaptive device (see FIG. 9). In a situation in which high quality sound is required, for example in a stereo system, it may be necessary to operate in parallel so that the stereo signals are handled in parallel for better cancellation of the audio signal originating from the audio unit i.e. in order to extract the locally generated speech more effectively.

The mechanism 54 may also include a fixed filter which limits the working of the adaptive portion of the mechanism to the same band as the filter 52.

The mixer 50 amplifies the desired speech signal to a level which is comparable to the amplitudes of the other signals or even to a predetermined user-settable level. The speech signal is then mixed with the audio signal originating from the unit 10 which is destined for the speakers 12.2 to 12.4. Volume may be controlled by means of a conventional device 62. The device 62 could also, to some extent, be controlled automatically, by means of a processor 63, which is responsive to background noise levels so that, as has been described hereinbefore, the volume of the audio input signal is automatically adjusted in a manner which is dependent on the background noise level. Thus if the audio unit volume level is increased the amplitude of the mixed speech signal is also increased. The volume adjustment may be effective for individual speakers or for groups of speakers.

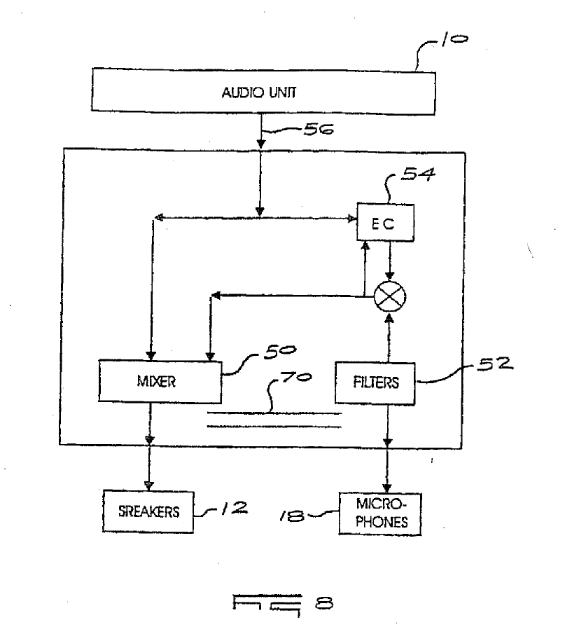

It is possible to combine a microphone with a loudspeaker in the sense that these devices are integrally formed. In this instance the arrangement shown in FIG. 6 is slightly simplified to that shown in FIG. 7. The operation of the speech distribution system shown in FIG. 7 is however effectively the same as what has been described in connection with FIG. 6. This approach would however require more accurate signal processing to extract the received signal (microphone action) from the much bigger output signal (loudspeaker action).

FIGS. 1 and 2 illustrate systems which make use of a plurality of localised distribution units. In other words a distribution module 16 is associated with each respective loudspeaker. With this approach the system can be incorporated with minimal adjustments into the existing audio wiring system of the vehicle. With an audio system which has four loudspeakers this does however mean that five hardware items are required, namely the four distribution modules 16 and the main or central unit 14.

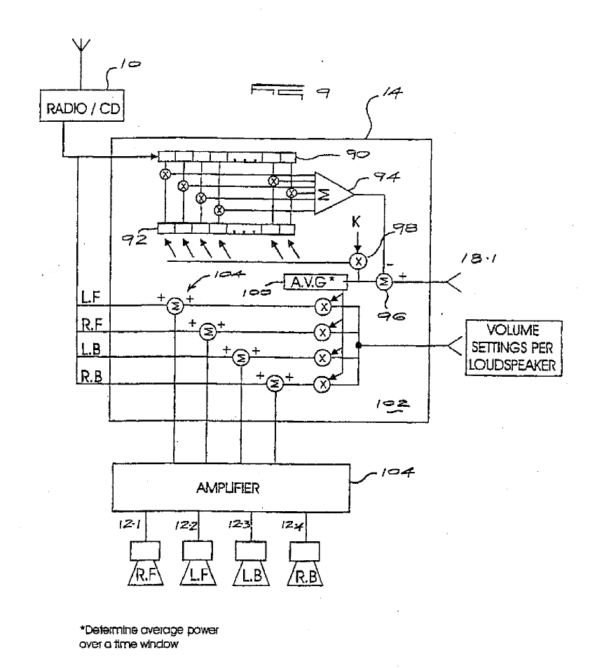

With a different approach it is possible to make use of centralised distribution. For example if the different microphones can be hardwired or if it can be assumed that the microphone signal can be transmitted over the loudspeaker wires or that the microphone is part of the loudspeaker then the system can be simplified as a central distribution unit. This technique is shown in FIG. 1a, FIG. 2a, FIG. 8 and FIG. 9.

The arrangement of FIG. 8 is substantially the same as that shown in FIG. 6. However as the loudspeakers 12 and the microphones 18 are effectively integral a connection 70 becomes effective which means that the loudspeaker signals and the microphone signals are transmitted over the same wires.

According to a further modification of the invention time delays can be built into the system to compensate for the differences in the transmission times of the physical sounds (the true acoustic sounds) and the electronic or electrical signals which represent the sounds and travel much faster. In this way discernible echoes or reverberation effects can be eliminated or minimised.

Another possibility is to incorporate the distribution system, whether in the form of a central distribution unit or a distributed unit, into the audio system of the vehicle. Separate hardware items are then not installed for the components necessary to implement the speech distribution system are incorporated in the audio system.

The system of the invention, inter alia because of the presence of processing power 63 (see FIG. 7) and sensors (driver microphone 60) lends itself to voice recognition processing of the speech signals. With this technology the driver can orally give commands to the sound distribution system, using the techniques already described, which allow the speech signals to be extracted. Since in one embodiment of the invention the speech extraction function is integrated with the audio system of the vehicle, oral commands can be given to the audio system as well. It is therefore possible to allow for an occupant, say the driver, to give oral commands. These commands are recognized by suitable software 65 which generates control signals 67 in response thereto, e.g. to change a selected radio station or to adjust the volume level, a CD track or disk etc. These features are convenient and improve safety through reducing the need for the driver to look away from the road.

Similarly, oral commands can be used to control other vehicle functions (69) such as setting a speed control unit, turning lights on and off, controlling wiper functions, mobile phone functions and the like. This may be done in conjunction with pressing an “audio command” activation button 71 that should typically be located on the steering wheel. It would be desirable for this unit to control, via voice command from the driver, the answering and dialing of a vehicular based mobile phone. The volume of the audio unit can then automatically be reduced and a particular occupant primarily targeted for the phone conversation or all occupants equally. Voice commands may be used for entertainment systems (DVD, VHS, TV), a radio station, electronic guidance (GPS) control and address selection, climatic control (A/C, heating), and the like.

In a further embodiment (see FIG. 10) the passengers would have a switch, or two switches 80, 82 (for + and −) to adjust the speech signal louder or softer at their particular locations. This would enable passengers with bad hearing to adjust the volume of speech louder at their location without affecting other people or requiring the driver to do it for them. It is also possible for all the speech signals received from various microphones (18) to be normalised before being adjusted by the level setting from each location and mixed with other signals to be sent to the various locations (seats). As such the effects of different passengers talking louder and softer as well as effects such as sitting closer to or further from a microphone can be negated to have a uniform level of speech signals conforming to the settings at each location. Such a system would need additional wires or another mechanism to carry the setting signals back to the central unit where the mixing is done. A central override is also possible.

In FIG. 9 a system equivalent to FIG. 1a is shown but with the main unit 14 of FIG. 1 depicted in more detail. In FIG. 9 the loudspeakers are marked 12.1 to 12.4 but they are conventionally distinguished from one another as LF (left front), RF (right front), LB (left back) and RB (right back).

In the system of FIG. 9 the signals from the radio/CD unit 10, with their relative volumes as they would go to the various loudspeakers, are fed into the main unit 14. All the functions required of the unit 14 can be substantially performed in a single digital processor, or some can be done in analogue, for example the final mixing, which is described hereinafter with reference to a stage 104.

A digital filter is associated with each microphone although in this case only one microphone is shown. A signal from the radio unit 10 is fed into a shift register delay line 90 of the digital filter. The values from the delay line are then multiplied with the digital filter coefficients 92 and summed in an accumulator 94. The result is an estimate of the part of the microphone signal that represents the signals from the radio unit subjected to the transfer functions of the loudspeakers, the microphones and the media between them. This value is subtracted (step 96) from the signals detected by the microphone 18.1 to give a signal which, as has been discussed elsewhere, represents the error signal driving the filter adaptation process and also the signals of other sounds like speech originating close to the microphone.

In a stage 98 the error signal is multiplied with a coefficient that determines the adaptation rate and also the smoothness of the adaptation. The error signal is then further used to drive the filter coefficients 92. From the same signal, but on the signal side, an average power is determined in a step 100. This is useful to help keep signals adjusted or to set values at the various locations. The signal from the microphone may also be analysed in terms of content and power to prevent a situation in which no speech is present and only noise is being inserted into the system and amplified. This error (speech) signal is then adjusted in a stage 102 to reflect the volume settings of the speech to the various loudspeakers.

In a step 104 the final mix takes place between the signals from the radio unit 10 with the speech signals which are now volume adjusted. This can be done at a small signal level and the resulting signal is amplified (104) and is then sent to the various loudspeakers.

1. A method of distributing speech in the presence of an audio system and using a single microphone (18.1) which includes the steps of:
(a) at a first location receiving a first audio signal (S1a) through a single microphone (18.1), the first audio signal including a second signal related to an output of the audio system, a voice signal representing speech originating from or near the first location, and noise (AS1m),
(b) extracting from the first audio signal a third signal (S1ae¹), representing the voice signal and the noise, by subtracting from the first audio signal an estimation of the second signal, determined by using an electrical output signal (Ase) of the audio system on its own as a reference signal for an adaptive filter, (52), the third signal being extracted directly from the first audio signal and without going through a loudspeaker and microphone first,
(c) amplifying the third signal and then mixing the third signal (S1ae¹) with the electrical output signal (Ase) to produce a combined output signal,
(d) distributing the combined output signal through the audio system to at least one loudspeaker (12.2 to 12.4), said method further including at least one of the following steps:
(i) automatically adjusting the level of amplification of the third signal in step (c) based on at least the level of background noise;
(ii) individually adjusting the level of amplification of the third signal in step (c) for each loudspeaker;
(iii) reducing the third signal in step (c) if it is determined that no speech is present in the first audio signal (S1a), and
(iv) using the combined output(s) as reference input(s) to an adaptive echo cancellation mechanism (54) to reduce acoustic feedback.

2. A method according to claim 1 further comprising the step of directing the amplified third signal to an electrical input of a mobile phone in order to reduce the influence of the sounds from the audio system in the speech signal going to the phone.

3. A method according to claim 1 wherein step (d) comprises the step of distributing the second output signal to a plurality of locations within a motor vehicle, the plurality of locations corresponding to seating positions inside the vehicle.

4. A method according to claim 1 further comprising the step of using the third signal in (c) for speech recognition processing to control at least one of the following:
signal strength of the distributed second output signal;
audio system volume;
CD selection;
track selection;
mobile phone functions;
radio station selection;
wiper functions;
lights;
climatic control;
electronic guidance control; and
entertainment system control;
where said speech recognition processing is initiated with an activation button.

5. A method according to claim 1 further comprising the steps of calculating a transfer function during a set up procedure and storing coefficients of digital filter to be used to extract the third signal in step (b), and then loading the stored coefficients into the filter when at least the filter is activated.

6. A method according to claim 1 whereby a delay is introduced into the extracted voice signal before it is combined with the output from the audio system, based on the physical position of the loudspeaker, to reduce the effect of the difference in the speed at which sound travels and the speed of electric signals.

7. A method according to claim 6 further comprising the steps of recognizing a substantial change in the transfer function and storing a new set of coefficients for future use.

8. A method according to claim 1 further comprising the steps of introducing a delay in the third signal, said delay having a relationship to the distance between the loudspeaker and the microphone, for each individual loudspeaker.

9. Apparatus for distributing speech in the presence of a first audio signal (As) produced by an audio system (10), the apparatus comprising
a receiving device (18.1) for receiving an acoustic signal (S1a, As1m) from at least one of a plurality of locations, the acoustic signal including at least a second signal related to an output signal of the audio system, a voice signal (S1a) representing speech originating at least from or near the one location and noise,
a module (1.1) for extracting from the received acoustic signal a third signal which represents the voice signal and the noise, by subtracting from the received acoustic signal an estimation of the second signal which is calculated using an electrical output signal of the audio system without mixing it with other signals as reference signal to an adaptive filter and the received acoustic signal, the third signal being extracted directly from the first audio signal and without going through a loudspeaker and microphone first, and the apparatus further comprising at least one of the following configurations
(i) a distribution unit (14, 16.2 to 16.4) for distributing a combined output signal, which includes the extracted voice signal and the first audio signal, to at least some of the locations, the third signal being amplified to a level that is at least influenced by the level of background noise,
(ii) a distribution unit (14, 16.2 to 16.4) for distributing a combined output signal, which includes the extracted voice signal and the first audio signal, to an input to a mobile phone,
(iii) at least one adaptive filter, with coefficients for the adaptive filter(s) determined during an installation or setup procedure and then stored in memory for use when the filter is activated,
(iv) an adaptive echo cancellation filter (54) receiving the electrical signals going to the loudspeakers for reducing acoustic feedback.

10. Apparatus according to claim 9 wherein the distribution unit includes means for distributing the combined output signal(s) to each of the plurality of locations but with a reduced output level to the at least one location from which the acoustic signal was received.

11. Apparatus according to claim 9 wherein the receiving device comprises a microphone which is one of a plurality of microphones each of which is associated with one of a related plurality of locations.

12. Apparatus according to claim 9 wherein the module comprises at least a second adaptive filter for echo cancellation of the amplified signals using the electrical signal(s) going to the loudspeaker(s) as reference inputs.

13. Apparatus according to claim 12 further comprising a central unit coupled to the first filter that receives the acoustic signal over conductive lines which are used for distributing said first audio signal.

14. Apparatus according to claim 12 wherein the module further comprises a white noise source from which white noise is added to the audio system before being output to loudspeakers, the first filter being responsive to the white noise to build a desired transfer function.

15. Apparatus according to claim 12 wherein the first filter comprises a digital filter and the module comprises a memory to store calculated coefficients of the digital filter, the coefficients being loaded into the first filter at start up.

16. Apparatus according to claim 9 further comprising a processor for controlling the signal strength of the extracted signal in a manner which is dependent on the level of the audio system output and background noise.

17. Apparatus according to claim 9 further comprising a control unit located at least at one of said plurality of locations to control the strength of the combined output signal distributed to that location.

18. Apparatus according to claim 9 further comprising a motor vehicle audio system which is integrated therein.

19. Apparatus according to claim 9 further comprising a central unit for adjusting the volume of the extracted voice signal that is mixed with the audio system output for distribution to the various locations.

20. Apparatus according to claim 9 further comprising delay means for compensating for differences in transmissions times of electrically distributed signals and acoustically propagated signals to the plurality of locations.

21. Apparatus according to claim 9 further comprising a single microphone for mainly distributing enhanced voice from a front to a rear of a vehicle.

22. Apparatus according to claim 9 further comprising a duplication of some filters to better estimate the signal to be removed in a stereo system by feeding each stereo signal without being mixed with other signals, as a reference signal into the adaptive filters.

23. Apparatus according to claim 9 wherein the combined output signal is varied in strength per output location, thereby broadcasting the combined output signal at different amplitudes to the various output locations.

24. Apparatus according to claim 9 whereby only signals representing voice and noise from a specific location are used as an input to a phone.

25. Apparatus according to claim 24 whereby phone communication is enhanced by using adaptive filter(s) that effectively reduce the contribution of the audio system output to the signal output of the microphone feeding into the phone, said adaptive filter(s) use as reference the electrical output of the audio system.

26. A method of distributing speech in the presence of an audio system which comprises the steps of:
(a) receiving at least one first location a first audio signal (S1a) through a microphone (18.1, 18.2, 18.3, 18.4), the first audio signal including a second signal related to an output of said audio system, a voice signal representing speech origination from or near at least one of the first locations and background noise (AS1m),
(b) extracting from the first audio signal (S1a) a third signal (S1ae¹), representing the voice signal and the noise, by subtracting from the first audio signal an estimation of the second signal, determined by using an electrical output signal (Ase) of the audio system as a reference signal for an adaptive filter, (52) the third signal being extracted directly from the first audio signal and without going through a loudspeaker and microphone first,
(c) mixing the third signal (S1ae¹) with the electrical output signal (Ase) to produce a combined output signal,
(d) distributing the combined output signal through the audio system to at least one loudspeaker (12.2 to 12.4), said method further including at least one of the following steps:
(i) monitoring the background noise and automatically adjusting the amplification of the speech signal to reflect variations in the level of the background noise,
(ii) applying delays, corresponding to the distance between the microphone(s) and the loudspeaker(s) based on the speed of sound, to the distribution of the third signal,
(iii) routing the third signal extracted from a first audio signal associated with a specific location to a vehicle based mobile phone input and routing the output from the mobile phone to the loudspeaker of the same specific location, and
(iv) reducing acoustic feedback through adaptive echo cancellation (54) based on the electrical signals going to the loudspeakers being used as an input to an adaptive echo canceller.

27. A method according to claim 26 further comprising the steps of receiving a respective first audio signal from each of the locations, and distributing respective combined output signals which correspond to each third signal extracted for the various locations, respectively to multiple loudspeakers.

28. A method according to claim 26 further comprising the steps of filtering each respective first audio signal received from each of the locations to form a filtered signal, and shifting the filtered signal in frequency to form a shifted signal that can be transmitted to a central unit on conductive lines which are also used for the transmission of audio signals to said at least one loudspeaker.

29. A method according to claim 26 wherein the third signal from a specific location can be used as input to a system for recognizing voice commands.

30. A method according to claim 27 further comprising the step of adjusting the strength of the third signal, for each of the locations before it is mixed into the audio system output in step (c), individually at each location.

31. A method according to claim 26 further comprising the steps of calculating the transfer function during a set up procedure and storing the coefficients of a digital filter which is used to extract the third signal in step (b), and then loading the stored coefficients into the filter when at least the filter is activated.

32. A method according to claim 26 further comprising the step of analyzing at least one signal received over the microphone to determine the presence of speech and squelching the third signal of step (c) when speech is absent.

33. A method according to claim 26 whereby a delay is introduced into the extracted voice signal before it is combined with the output of the audio system, based on the physical position of the loudspeaker, to reduce the effect of the difference in the speed at which sound travels and the speed of electric signals.
